(19) United States
(12) Patent Application Publication
(10) Pub. No.: US 2018/0284500 A1
(43) Pub. Date: Oct. 4, 2018

(54) OPTICAL WAVEGUIDE DISPLAY ASSEMBLY, ELECTRONIC DEVICE, AND FABRICATING METHOD THEREOF

(71) Applicant: BOE TECHNOLOGY GROUP CO., LTD., Beijing (CN)

(72) Inventors: Xin Li, Beijing (CN); Hongfei Cheng, Beijing (CN)

(73) Assignee: BOE TECHNOLOGY GROUP CO., LTD., Beijing (CN)

(21) Appl. No.: 15/565,777

(22) PCT Filed: May 23, 2017
(86) PCT No.: PCT/CN2017/085500

§ 371 Date: Oct. 11, 2017

(30) Foreign Application Priority Data
Jul. 29, 2016 (CN) 201610618088.2

(51) Int. Cl. G02F 1/1334; G02F 1/1335; G02F 1/1343; C09K 19/54

(52) U.S. Cl. CPC G02F 1/1334; G02F 1/133524; G02F 1/133553; G02F 1/134309; C08G 63/00; G02F 2201/123; G02F 2202/022; G02F 2201/121; C09K 19/544

(57) ABSTRACT

An optical waveguide display assembly, an electronic device, and a fabricating method thereof are provided. The optical waveguide display assembly includes: a display region, including a first portion and a second portion with a substantially same area, the first portion being closer to a light source than the second portion; and a macromolecular polymer, in the display region, having a concentration in the first portion lower than that in the second portion, and configured to scatter light emitted from the light source.

### CROSS-REFERENCES TO RELATED APPLICATIONS

This application claims the priority of Chinese Patent Application No. 201610618088.2, filed on Jul. 29, 2016, the entire contents of which are incorporated herein by reference.

### TECHNICAL FIELD

The present disclosure generally relates to the field of display technology, and more particularly, to an optical waveguide display assembly, an electronic device, and a fabricating method thereof.

### BACKGROUND

As display technology advances, transparent display products have been newly emerged. When a transparent display device is in operation, the user can clearly see scenes behind the transparent display device through the transparent display device. Because of this, the transparent display device has become more popular and has been gradually involved in store windows, smart glasses, smart helmet, and other products.

The transparent display device may include an optical waveguide transparent display module, which may provide higher light transmittance and better display than other transparent display devices.

However, the display module of the optical waveguide transparent display device may have poor display uniformity due to the attenuation effect of the optical waveguide transmission structure of the display module.

Accordingly, the disclosed optical waveguide display assembly, electronic device, and fabricating method thereof are directed to solve one or more problems set forth above and other problems.

### BRIEF SUMMARY

In accordance with some embodiments of the present disclosure, an optical waveguide display assembly, an electronic device, and a fabricating method thereof are provided.

One aspect of present disclosure provides an optical waveguide display assembly, including: a display region, including a first portion and a second portion with a substantially same area, the first portion being closer to a light source than the second portion; and a macromolecular polymer, in the display region, having a concentration in the first portion lower than that in the second portion, and configured to scatter light emitted from the light source.

In some embodiments, the display region includes a first side adjacent to the light source; the display region includes a plurality of sub-regions continuously arranged in a direction perpendicular to the first side and parallel to the display region; the plurality of sub-regions have a substantially same area; and in any adjacent sub-regions, a concentration of macromolecular polymer in one sub-region close to the first side is lower than a concentration of macromolecular polymer in another sub-region distant from the first side.

In some embodiments, the optical waveguide display assembly further includes: a reflection structure on a second side of the display region that is opposite to the light source.

In some embodiments, each of the first portion and the second portion includes a plurality of pixels, and each pixel includes a pixel electrode; and when a same voltage is applied to the plurality of pixel electrodes in the first portion and the second portion, the first portion and the second portion have a substantially same maximum luminance.

In some embodiments, the macromolecular polymer can include at least one of

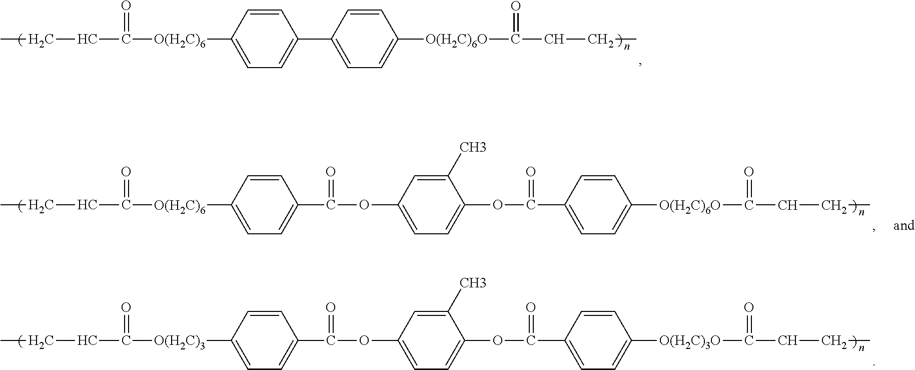

In some embodiments, the optical waveguide display assembly further includes common electrodes. An area of a common electrode in the first portion is smaller than an area of a common electrode in the second portion.

In some embodiments, each common electrode includes a plurality of hollow holes; in any adjacent sub-regions, a total area of hollow holes in one sub-region close to the first side is larger than a total area of hollow holes in another sub-region distant from the first side.

In some embodiments, the plurality of hollow holes are evenly distributed and have a substantially same shape.

Another aspect of the present disclosure provides an electronic device, including: the disclosed optical waveguide display assembly.

Another aspect of the present disclosure provides a method for forming an optical waveguide display assembly, including: forming a first substrate and a second substrate; forming a plurality of pixel electrodes and a plurality of common electrodes on the first substrate and the second substrate respectively; forming a liquid crystal layer between the first substrate and the second substrate; forming a display region include at least a portion of the liquid crystal layer, the first substrate, and the second substrate, the display region including a first portion and a second portion. The first portion is close to a light source; the second portion is distant from the light source; an area of the first portion is equal to an area of the second portion; and a concentration of macromolecular polymer in the liquid crystal layer in the first portion is lower than a concentration of macromolecular polymer in the liquid crystal layer in the second portion.

In some embodiments, forming the liquid crystal layer includes: forming a mixture including a liquid crystal material and a plurality of monomers; and irradiating the mixture using ultraviolet light, such that the plurality of monomers dispersed in the liquid crystal material undergoes a polymerization reaction to form a macromolecular polymer.

In some embodiments, the polymerization process further includes: controlling a reaction parameter of the polymerization reaction to control the concentration of the macromolecular polymer in the liquid crystal layer in the first portion to be lower than the concentration of macromolecular polymer in the liquid crystal layer in the second portion.

In some embodiments, the reaction parameter includes at least one of a polymerization temperature, an irradiating time, and an irradiating intensity.

In some embodiments, the polymerization reaction further includes: using an ultraviolet light having an even intensity to irradiate the entire liquid crystal layer. An irradiating time of the first portion of the liquid crystal layer is shorter than an irradiating time of the second portion of the liquid crystal layer.

In some embodiments, the polymerization process further includes: applying a same irradiating time to the entire liquid crystal layer. An ultraviolet intensity for irradiating the first portion of the liquid crystal layer is weaker than an ultraviolet intensity for irradiating the second portion of the liquid crystal layer.

In some embodiments, forming the liquid crystal layer includes: forming a plurality of cavities between the first substrate and the second substrate; and filling mixtures of a liquid crystal and a plurality of monomers into each of the plurality of cavities respectively, wherein one of the plurality of cavities has a larger distance from a light source is filled with a mixture having a higher concentration of the monomers.

Other aspects of the present disclosure can be understood by those skilled in the art in light of the description, the claims, and the drawings of the present disclosure.

### BRIEF DESCRIPTION OF THE DRAWINGS

Various objectives, features, and advantages of the present disclosure can be more fully appreciated with reference to the detailed description of the present disclosure when considered in connection with the following drawings, in which like reference numerals identify like elements. It should be noted that the following drawings are merely examples for illustrative purposes according to various disclosed embodiments and are not intended to limit the scope of the present disclosure.

FIG. 1 illustrates a schematic structural diagram of an optical waveguide display assembly in accordance with some embodiments of the present disclosure;

FIG. 2 illustrates a schematic diagram of different portions of an exemplary optical waveguide display assembly in accordance with some embodiments of the present disclosure;

FIG. 3 illustrates a schematic diagram of an exemplary arrangement of electrodes of an optical waveguide display assembly in accordance with some embodiments of the present disclosure;

FIG. 4 illustrates a schematic diagram of another exemplary arrangement of electrodes of an optical waveguide display assembly in accordance with some embodiments of the present disclosure;

FIG. 5 illustrates a schematic diagram of an exemplary concentration relationship of a macromolecular polymer in different regions of an optical waveguide display assembly in accordance with some embodiments of the present disclosure; and

FIG. 6 illustrates a schematic flow diagram of an exemplary process for fabricating an optical waveguide display assembly in accordance with some embodiments of the present disclosure.

### DETAILED DESCRIPTION

Reference input now be made in detail to exemplary embodiments of the invention, which are illustrated in the accompanying drawings in order to understand and implement the present disclosure and to realize the technical effect. It should be understood that the following description has been made only by way of example, but not to limit the present disclosure. Various embodiments of the present disclosure and various features in the embodiments that are not conflicted with each other can be combined and rearranged in various ways. Without departing from the spirit and scope of the present disclosure, modifications, equivalents, or improvements to the present disclosure are understandable to those skilled in the art and are intended to be encompassed within the scope of the present disclosure.

In accordance with various embodiments, the present disclosure provides an optical waveguide display assembly, an electronic device, and a fabricating method thereof.

In some embodiments, the disclosed optical waveguide display assembly can include: a display region, including a first portion and a second portion with substantially same area, the first portion being closer to a light source than the second portion; and a macromolecular polymer, in the display region and having a concentration in the first portion lower than that in the second portion. The macromolecular polymer may be configured to scatter light emitted from the light source.

In some alternative embodiments, the disclosed optical waveguide display assembly can include: a display region including a first portion and a second portion with substantially same area, the first portion being closer to a light source than the second portion; and an area of a common electrode in the first portion is smaller than an area of a common electrode in the second portion.

Referring to FIG. 1, a schematic structural diagram of an optical waveguide display assembly is shown. The optical waveguide display assembly can include a first substrate, a second substrate, and a liquid crystal layer between the first substrate and the second substrate.

When receiving an electric signal, the liquid crystal layer may be in a scattering state, which damages the total reflection conditions of the light. In this case, the light can be transmitted to exit the optical waveguide transmission structure. In other cases, when the liquid crystal layer is in a transmitting state, the light may undergo a total reflection within the optical waveguide transmission structure and cannot exit the optical waveguide transmission structure.

As shown in FIG. 1, due to the attenuation of the optical waveguide transmission structure, as the distance from a pixel to the light source become farther, the intensity of the original indecent light on the pixel becomes lower. Therefore, applying a same electrical signal to different pixels in the optical waveguide transmission structure, the brightness of the different pixels can be different. That is, the display module may have a poor uniformity of the display effect.

In some embodiments, the optical waveguide display assembly scattering ability can be designed according to distances from different portions of the optical waveguide display assembly to the light source. A portion of the optical waveguide display assembly has a larger distance from the light source area, the portion of the optical waveguide display assembly can have a stronger scattering capacity. That is, the angle of the incident light can be changed to destroy the total reflection condition. As such, the uneven display problem caused by the light attenuation can be compensated to improve the display uniform performance of the optical waveguide display assembly.

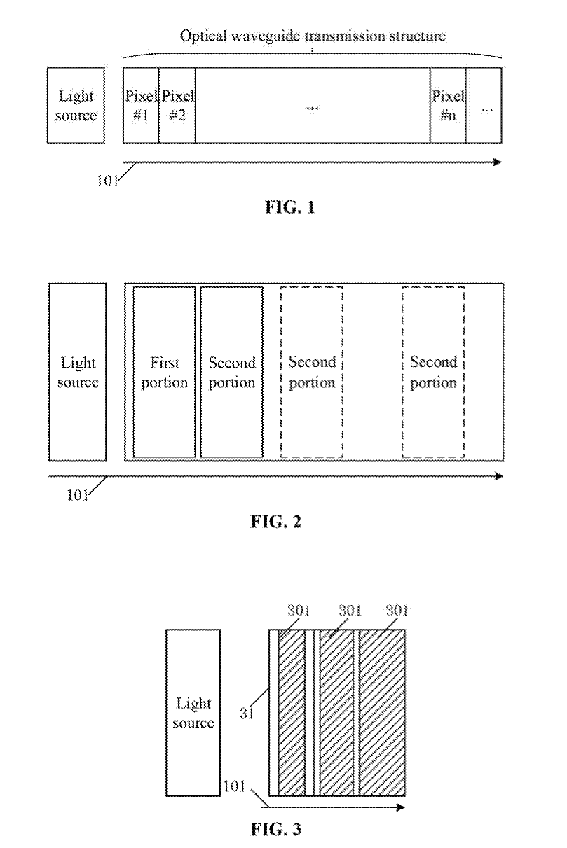

Referring to FIG. 2, a schematic diagram of different portions of an exemplary optical waveguide display assembly is shown in accordance with some embodiments of the present disclosure.

As illustrated, the optical waveguide display assembly can have a display region including a first portion and a second portion. The first portion and the second portion can have a substantially same area. A scattering capability of the first portion is weaker than a scattering capability of the second portion when the voltages of the electrical signals applied to the pixel electrodes in the first portion and the second portion are equal.

As shown in FIG. 2, the first portion in the optical waveguide display assembly can be close to the light source. The second portion in the optical waveguide display assembly can be distant from the light source.

Further, the second portion may be located at different positions in the display region with respect to the first portion, as long as a second distance from the second portion to the light source is greater than a first distance from the first portion to the light source. That is, the rust portion and the second portion can be located arbitrarily on any positions of the optical waveguide display assembly, as long as the first portion is located between the light source and the second portion.

Accordingly, the optical waveguide display assembly scattering ability can be designed according to distances from different portions of the optical waveguide display assembly to the light source. A portion of the optical waveguide display assembly has a larger distance from the light source area, the portion of the optical waveguide display assembly can have a stronger scattering capacity. That is, the angle of the incident light can be changed to destroy the total reflection condition. As such, the uneven display problem caused by the light attenuation can be compensated to improve the display uniform performance of the optical waveguide display assembly.

The disclosed optical waveguide display assembly can be implemented by various embodiments, which are described in detail in the following.

Referring back to FIG. 1, in some embodiments, an electric field can be applied to the common electrode and the pixel electrode to form an electric field acting on the liquid crystal layer. The state of the liquid crystal layer can be changed by the electric field. Therefore, the larger area affected by the electric field, the more liquid crystal molecules in the area can be switched to another state, resulting a stronger scattering ability of the indecent light.

Thus, the area of an electrode can be adjusted based on the first distance from the first portion to the light source and the second distance from the second portion to the light source. The portion that is not covered by the electrode cannot generate an electric field to affect the corresponding liquid crystal layer, so that the liquid crystal layer of the portion does not participate in the scattering of the incident light, thereby reducing the scattering ability.

The electrode that can be adjusted may be a pixel electrode or a common electrode. In some embodiment, in view of the convenience of implementation and the impact on the pixel display, the common electrode can be adjusted.

The first portion close to the light source needs a relatively weak scattering capacity because the first portion has more incident light. The second portion distant away from the light source needs a relatively strong scattering capacity because the second portion has less incident light.

When a same electric signal is applied, a common electrode has a larger area can affect a larger area of the liquid crystal layer, so that the corresponding liquid crystal layer can have a stronger scattering ability. A common electrode has a smaller area can affect a smaller area of the liquid crystal layer, so that the corresponding liquid crystal layer can have a weaker scattering ability.

Therefore, in some embodiments, an area of the common electrode in the first portion close to the light source can be smaller than an area of the common electrode in the second portion distant from the light source. As such, when the voltage of the electrical signals applied to the pixel electrodes in different portions are the same, the scattering capability of the first portion in the optical waveguide display assembly can be weaker than the scattering capability of the second portion in the optical waveguide display assembly.

It should be noted that, in some specific embodiments, in order to improve the display uniformity as much as possible, a part of the display region can be compensated by using the above described method. In some alternative embodiments, the whole display region can be compensated by using the above described method, so as to improve the display uniformity as much as possible.

Referring to FIG. 3, a schematic diagram of an exemplary arrangement of electrodes of an optical waveguide display assembly is shown in accordance with some embodiments of the present disclosure.

As illustrated, the display region in the optical waveguide display assembly can have a rectangular shape. The rectangular display region can include a first side 31 adjacent to the light source. The rectangular display region can be divided into a plurality of sub-regions 301 which are continuously distributed in a direction 101 perpendicular to the first side 31 and parallel to the display region. As shown in FIG. 3, three sub-regions 301 are shown as an example, although any number sub-regions, more or less than three, can be included in the present disclosure.

In any two adjacent sub-regions 301, an area of the common electrode (having slashes as shown in FIG. 3) in the sub-region close to the first side 31 can be smaller than an area of the common electrode in the sub-region distant from the first side 31. The areas of all pixel electrodes in the display region can be the same.

As shown in FIG. 3, in the direction 101 from the left to the right, the distance away from the light source can become farther, and the corresponding common electrode can have a larger area. Further, the incident light in each sub-region can become weaker. Although the pixel electrodes in each sub-region can have a substantially same area, the corresponding common electrodes can have larger area in the direction 101 from the left to the right. Therefore, under the same electrical signal, the scattering ability of the liquid crystal layer can become stronger. As such, when the incident light in each sub-region becomes weaker, the optical waveguide display assembly can still ensure a relatively, stably emitted light.

In some embodiments as shown in FIG. 3, each sub-region can have a respective common electrode. In some other embodiments, a common electrode can be used for a whole area.

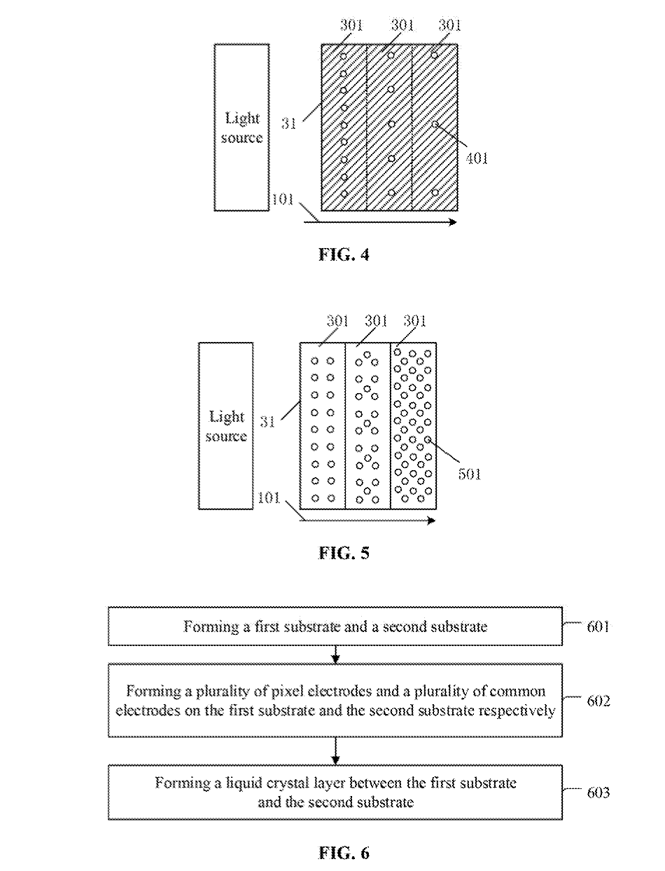

Referring to FIG. 4, a schematic diagram of another exemplary arrangement of electrodes of an optical waveguide display assembly is shown in accordance with some embodiments of the present disclosure.

As illustrated, the common electrode can include a plurality of hollow holes 401. The hollow holes 401 may be distributed over different sub-regions, for example, along a direction 101 shown in FIG. 4. In any two adjacent sub-regions 301, a total area of the hollow holes 401 in the sub-region close to the first side 31 can be larger than a total area of the hollow holes 401 in the sub-region distant from the first side 31.

In some specific embodiments, the plurality of hollow holes 401 may have different cross-sectional shapes. In some other specific embodiments, the plurality of hollow holes 401 can have a same cross-sectional shape in order to facilitate the production, and in order to avoid an excessive concentration of the hollow holes 401. In each sub-region, the hollow holes 401 can be evenly distributed.

In order to further reduce the effect on the display, in some embodiments, each of the plurality of hollow holes 401 has an area less than an area of a single pixel, and a number of the hollow holes 401 in each sub-region 301 can be less than 10% of the number of pixels in the sub-region.

That is, using the above described design, it can be ensured that each pixel can correspond to at least a common electrode.

Referring back to FIG. 1, in some alternative embodiments, an electric field can be applied to the common electrode and the pixel electrode to form an electric field acting on the liquid crystal layer. The states of a plurality of liquid crystal molecules in the liquid crystal layer can be changed by the electric field. Therefore, the more liquid crystal molecules in the area can be switched to another state, a stronger scattering ability of the indecent light can be achieved.

As described above, the optical waveguide display assembly can include an optical waveguide structure, including a first substrate, a second substrate, and a liquid crystal layer between the first substrate and the second substrate.

In the optical waveguide display assembly, the liquid crystal layer can generate effect to the incident light. The liquid crystal layer can include a macromolecular polymer and liquid crystal particles distributed in the macromolecular polymer. Under an action of an electric field, the refractive index of the liquid crystal particles and the refractive index of the macromolecular polymer can be different. If no electric field is applied, the refractive index of the liquid crystal particles and the refractive index of the macromolecular polymer can be the same or similar.

In some embodiments, a material of the liquid crystal layer is a macromolecular polymer-stabilized liquid crystal (PSLC).

In some other embodiments, a material of the liquid crystal layer includes a nematic liquid crystal, and a long chain compound dispersed in the nematic liquid crystal. The long chain compound can be used for forming the liquid crystal in a scattering state. The long chains of the long chain compound can be perpendicular to the display region described above.

The long chain compound can include a plurality of monomers. The monomers can include any one or a combination of the following:

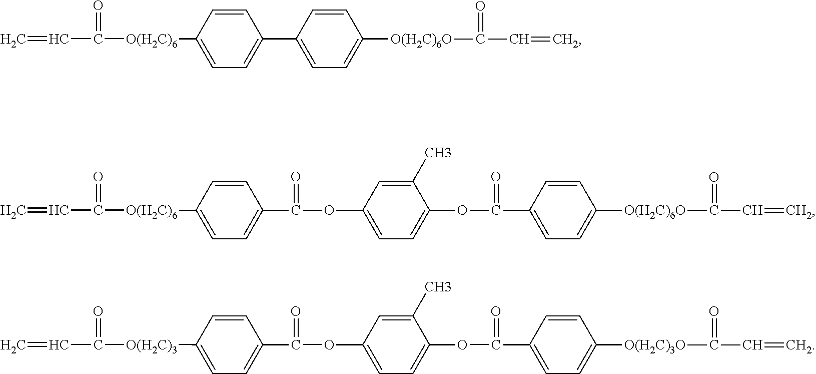

The long chain compound can include any one or a combination of the following:

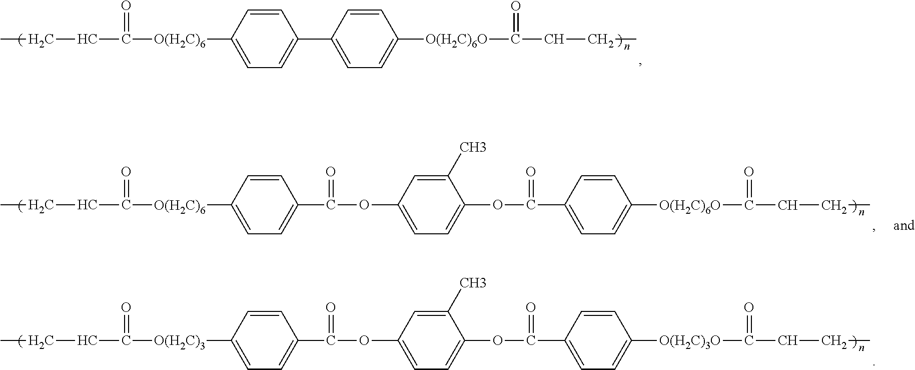

The nematic liquid crystal can include any one or a combination of the following liquid crystal molecules:

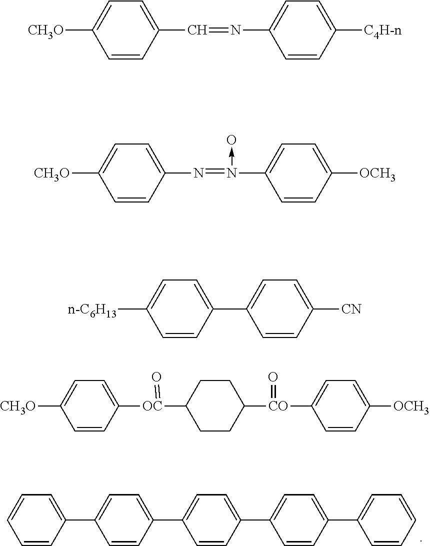

The constitution of the liquid crystal layer described above is not limited according to various embodiments of the present disclosure.

During a process for forming the liquid crystal layer, the monomers and the liquid crystal can be mixed and then irradiated by ultraviolet light. The monomers can be connected with each other to form a macromolecular polymer. At the same time when forming the macromolecular polymer, the liquid crystal can be separated from the macromolecular polymer to form a plurality of small liquid crystal particles. These small liquid crystal particles can be fixed in place by the macromolecular polymer.

When an electric field is applied, the liquid crystal can be disordered by the influence of the macromolecular polymer. The difference between the refractive index of the macromolecular polymer and the refractive index of the liquid crystal can be formed. As such, the incident light can be refracted and reflected at the surfaces of the liquid crystal particles. For a part of the incident light, the total reflection condition can be destroyed. Therefore, after several reflections and refractions, the part of the incident light can be transmitted to exit the liquid crystal layer to form a bright state.

When there is no electric field applied, the liquid crystal and the macromolecular polymer can have a same refractive index. Thus, the liquid crystal and the macromolecular polymer are transparent to incident light. As such, the total reflection condition of the incident light can be maintained. Therefore, the incident light can be constrained in the optical waveguide transmission structure, and cannot exit from the liquid crystal layer.

It should be noted that, when the design of the electrodes has a uniformity, that is, when each electrode has an exactly same design regardless in any region, and when the applied electrical signals are the same, the scattering capacity of each region of the optical waveguide transmission structure can depend on the concentration of the macromolecular polymer in the corresponding region.

If one region has a higher concentration of the macromolecular polymer, the macromolecular polymer can have a stronger ability to affect the orientation of the liquid crystal. Therefore, more quantity of the liquid crystal particles can be affected, and more quantity of times the incident light can be reflected and refracted in the region. Eventually, more light can be transmitted to exit from the optical waveguide structure.

In some embodiments, the concentration of the macromolecular polymer in the first portion in the optical waveguide display assembly can be lower than the concentration of the macromolecular polymer in the second portion in the optical waveguide display assembly.

Since the first portion has a lower concentration of the macromolecular polymer, it can affect less number of liquid crystal particles. As such, when the voltages of the electrical signals applied to the pixel electrodes are same, the scattering capability of the first portion in the optical waveguide display assembly can be weaker than the scattering capability of the second portion in the optical waveguide display assembly.

Accordingly, in some embodiments, the disclosed optical waveguide display assembly can have a display region including a first portion and a second portion. The first portion in the optical waveguide display assembly can be close to the light source. The second portion in the optical waveguide display assembly can be distant from the light source. The first portion and the second portion can have a substantially same area. The concentration of the macromolecular polymer in the first portion in the optical waveguide display assembly can be lower than the concentration of the macromolecular polymer in the second portion in the optical waveguide display assembly.

A concentration of a substance can be characterized by an amount of substance per unit volume. Specifically to the macromolecular polymer, the concentration can be expressed as a number of macromolecular polymer chains per unit volume.

In some specific embodiments, in order to improve the display uniformity as much as possible, a part of the display region can be compensated. In some alternative embodiments, the whole display region can be compensated to improve the display uniformity as much as possible.

Referring to FIG. 5, a schematic diagram of an exemplary concentration relationship of a macromolecular polymer in different regions of an optical waveguide display assembly is shown in accordance with some embodiments of the present disclosure.

As illustrated, the display region in the optical waveguide display assembly can have a rectangular shape. The rectangular display region can include a first side 31 adjacent to the light source. The rectangular display region can be divided into a plurality of sub-regions 301 which are continuously distributed in a direction 101 perpendicular to the first side 31 and parallel to the display region. As shown in FIG. 5, three sub-regions 301 are shown as an example, although any number sub-regions, more or less than three, can be included in the present disclosure.

In any two adjacent sub-regions 301, a concentration of the macromolecular polymer 501 in the sub-region close to the first side 31 can be smaller than concentration of the macromolecular polymer 501 in the sub-region distant from the first side 31.

As shown in FIG. 5, in the direction 101 from the left to the right, the distance away from the light source can become larger, and the corresponding sub-region can have a larger amount of macromolecular polymer 501. That is, the concentration of the macromolecular polymer 501 in each sub-region can become higher. Further, the incident light in each sub-region can become weaker.

However, under the same electrical signals, since the concentration of the macromolecular polymer 501 in each sub-region can become higher, the ability to affect the liquid crystal particles under the same electrical signal can become stronger. As such, in the direction 101 from the left to the right and away from the light source, the number of the affected liquid crystal particles can become more, so that the scattering ability of the liquid crystal layer can become stronger. Therefore, when the incident light in each sub-region becomes weaker, the optical waveguide display assembly can still ensure a relatively, stably emitted light.

In some embodiments, in order to improve light utilization efficiency and to increase the display brightness, the optical waveguide display assembly can further include a reflection structure (not shown) on an opposite side of the light source of the display region.

By using the reflection structure, the light emitted from the optical waveguide structure can be re-reflected into the optical waveguide structure. Thus, the utilization ratio of the light can be improved, and the display brightness can be increased.

In some embodiments, in order to improve the display uniformity of the display module, when the voltage of the electric signals applied to the pixel electrodes are same, a difference between a first total luminance of the pixels corresponding to the first portion in the optical waveguide display assembly and a second total luminance of the pixels corresponding to the second portion in the optical waveguide display assembly can be less than a predetermined threshold. For example, the first portion and the second portion may have a maximum luminance substantially the same.

As mentioned above, in some embodiments, the display uniformity of the display module can be improved by changing the concentration of the macromolecular polymer 501.

Referring to FIG. 6, a schematic flow diagram of an exemplary process for fabricating an optical waveguide display assembly is shown in accordance with some embodiments of the present disclosure. The optical waveguide display assembly can include a display region. The process for fabricating an optical waveguide display assembly can include the following steps.

At step 601, a first substrate and a second substrate can be provided.

At step 602, a pixel electrode and a common electrode can be formed on the first substrate and the second substrate respectively.

At step 603, a liquid crystal layer can be formed between the first substrate and the second substrate.

In some embodiments, the formed optical waveguide display assembly can have a display region including a first portion and a second portion. The first portion in the optical waveguide display assembly can be close to the light source. The second portion in the optical waveguide display assembly can be distant from the light source. The first portion and the second portion can have a substantially same area. The concentration of the macromolecular polymer in the first portion in the optical waveguide display assembly can be lower than the concentration of the macromolecular polymer in the second portion in the optical waveguide display assembly.

In some embodiments, the concentration of the macromolecular polymer can be controlled by using different mixtures of the liquid crystal and the monomers for different regions. For example, a plurality of cavities can be formed in the optical waveguide structure, and each cavity can be filled with different mixtures of the liquid crystal and the monomers. A cavity has a larger distance from the light source can be filled with a mixture having a higher concentration of the monomer(s).

Further, the mixtures can be irradiated by ultraviolet light uniformly, such that the monomer distributed in the liquid crystal can have a polymerization reaction to form the macromolecular polymer.

In some alternative embodiments, the concentration of the finally formed macromolecular polymer in different regions can be controlled according to the distances from the different regions to the light source. The concentration of the macromolecular polymer can be controlled by the reaction parameters during the polymerization reaction. Therefore, without preparing a unique mixture of liquid crystal and monomer for each region, the production difficulty can be greatly reduced.

In some embodiments, a process for forming the liquid crystal layer between the first substrate and the second substrate can include forming a mixture of a liquid crystal and a plurality of monomers, and using ultraviolet light to irradiate the mixture, such that the monomer distributed in the liquid crystal can have a polymerization reaction to form a macromolecular polymer.

By controlling a reaction parameter of the polymerization reaction, the concentration of the macromolecular polymer in the first portion in the liquid crystal layer can be lower than the concentration of the macromolecular polymer in the second portion in the liquid crystal layer.

The reaction parameter of the polymerization reaction can be at least one of a polymerization temperature, an irradiating time, and an irradiating intensity. For example, the polymerization temperature of the first portion can be lower than the polymerization temperature of the second portion. As another example, the irradiating time of the first portion can be shorter than the irradiating time of the second portion. As yet another example, the irradiating intensity of the first portion can be weaker than the irradiating intensity of the second portion.

In some embodiments, in the polymerization step, an ultraviolet light having an even intensity can be used to expose and irradiate to the entire liquid crystal layer. The irradiating time of the first portion of the liquid crystal layer can be shorter than the irradiating time of the second portion of the liquid crystal layer.

In some alternative embodiments, in the polymerization step, a same irradiating time can be applied to the entire liquid crystal layer. The ultraviolet intensity for irradiating the first portion of the liquid crystal layer can be weaker than the ultraviolet intensity for irradiating the second portion of the liquid crystal layer.

Since only one mixture is required to be generated, the irradiating time or the irradiating intensity can be used to control the concentration of the macromolecular polymer in different regions.

The present disclosure also provides an electronic device including any of the optical waveguide display assemblies described above.

In some embodiments, the optical waveguide structure can include a liquid crystal layer and a transparent substrate. The transparent substrate can be a glass substrate, a plastic substrate, or any other suitable transparent substrate. The liquid crystal layer and the transparent substrate can have different refractive indexed. In some specific embodiments, the refractive index of the liquid crystal layer can be larger than the refractive index of the transparent substrate.

In some embodiments, the optical waveguide transmission structure can increase the light transmittance, and can arrange partial liquid crystal molecules to be in a scattering state in response to an electrical signal. Therefore, the magnitude of the incident angle of the light propagating in the optical waveguide transmission structure can be changed, and the total reflection condition between the liquid crystal and the transparent substrate can be destroyed. As such, without using a polarizer, the light can be emitted from desired positions to realize the display function. Therefore, the light transmittance can be increased and the light utilization efficiency can be improved.

Further, in some embodiments, the optical waveguide display assembly scattering ability can be designed according to distances from different portions of the optical waveguide display assembly to the light source. A portion of the optical waveguide display assembly has a larger distance from the light source area, the portion of the optical waveguide display assembly can have a stronger scattering capacity. That is, the angle of the incident light can be changed to destroy the total reflection condition. As such, the uneven display problem caused by the light attenuation can be compensated to improve the display uniform performance of the optical waveguide display assembly.

Accordingly, an optical waveguide display assembly, an electronic device, and a fabricating method thereof are provided.

The provision of the examples described herein (as well as clauses phrased as “such as,” “e.g.,” “including,” and the like) should not be interpreted as limiting the claimed subject matter to the specific examples; rather, the examples are intended to illustrate only some of many possible aspects.

Further, the words “first”, “second” and the like used in this disclosure do not denote any order, quantity or importance, but are merely intended to distinguish between different constituents. The words “comprise” or “include” and the like mean that the elements or objects preceding the word can cover the elements or objects listed after the word and their equivalents, without excluding other elements or objects. The words “connect” or “link” and the like are not limited to physical or mechanical connections, but may include electrical connections, either directly or indirectly. The words “above”, “below”, “left”, “right” and the like are used only to represent the relative positional relationship, and the relative positional relationship may be changed accordingly when the absolute position of the corresponding object changes.

It also should be noted that, when an element, such as a layer, a film, a region, or a substrate, etc., is referred to as being “on” another element, the element may be “directly” on the other element, or there may be an intermediate element.

Although the present disclosure has been described and illustrated in the foregoing illustrative embodiments, it is understood that the present disclosure has been made only by way of example, and that numerous changes in the details of embodiment of the present disclosure can be made without departing from the spirit and scope of the present disclosure, which is only limited by the claims which follow. Features of the disclosed embodiments can be combined and rearranged in various ways. Without departing from the spirit and scope of the present disclosure, modifications, equivalents, or improvements to the present disclosure are understandable to those skilled in the art and are intended to be encompassed within the scope of the present disclosure.

1. An optical waveguide display assembly, comprising:
a display region, including a first portion and a second portion with a substantially same area, the first portion being closer to a light source than the second portion; and
a macromolecular polymer, in the display region, having a concentration in the first portion lower than that in the second portion, and configured to scatter light emitted from the light source.

2. The optical waveguide display assembly of claim 1, wherein:
the display region includes a first side adjacent to the light source;
the display region includes a plurality of sub-regions continuously arranged in a direction perpendicular to the first side and parallel to the display region;
the plurality of sub-regions have a substantially same area; and
in any adjacent sub-regions, a concentration of macromolecular polymer in one sub-region close to the first side is lower than a concentration of macromolecular polymer in another sub-region distant from the first side.

3. The optical waveguide display assembly of claim 2, further comprising:
a reflection structure on a second side of the display region that is opposite to the light source.

4. The optical waveguide display assembly of claim 1, wherein:
each of the first portion and the second portion includes a plurality of pixels, and each pixel includes a pixel electrode; and
when a same voltage is applied to the plurality of pixel electrodes in the first portion and the second portion, the first portion and the second portion have a substantially same maximum luminance.

5. The optical waveguide display assembly of claim 1, wherein:
the macromolecular polymer includes at least one of:

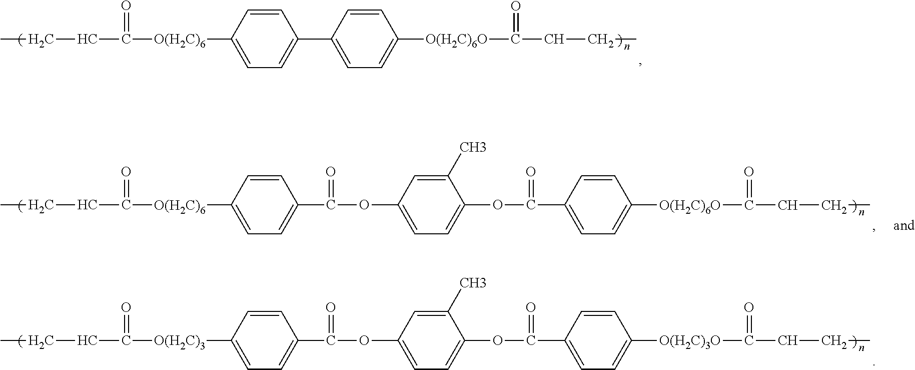

6. The optical waveguide display assembly of claim 1, further comprising:
common electrodes, wherein an area of a common electrode in the first portion is smaller than an area of a common electrode in the second portion.

7. The optical waveguide display assembly of claim 6, wherein:
each common electrode includes a plurality of hollow holes;
in any adjacent sub-regions, a total area of hollow holes in one sub-region close to the first side is larger than a total area of hollow holes in another sub-region distant from the first side.

8. The optical waveguide display assembly of claim 7, wherein:
the plurality of hollow holes are evenly distributed and have a substantially same shape.

9. An electronic device, comprising:
the optical waveguide display assembly according to claim 1.

10. A method for forming an optical waveguide display assembly, comprising:
forming a first substrate and a second substrate;
forming a plurality of pixel electrodes and a plurality of common electrodes on the first substrate and the second substrate respectively;
forming a liquid crystal layer between the first substrate and the second substrate and including a macromolecular polymer, wherein:
at least a portion of the liquid crystal layer, the first substrate, and the second substrate forms a display region,
the display region includes a first portion and a second portion with a substantially same area, the first portion being closer to a light source than the second portion, and
a concentration of the macromolecular polymer in the first portion is lower than that in the second portion.

11. The method of claim 10, wherein forming the liquid crystal layer includes:
forming a mixture including a liquid crystal material and a plurality of monomers; and
irradiating the mixture using ultraviolet light, such that the plurality of monomers dispersed in the liquid crystal material undergoes a polymerization reaction to form the macromolecular polymer.

12. The method of claim 11, wherein the polymerization process further includes:
controlling a reaction parameter of the polymerization reaction to control the concentration of the macromolecular polymer in the liquid crystal layer in the first portion to be lower than the concentration of macromolecular polymer in the liquid crystal layer in the second portion.

13. The method of claim 12, wherein the reaction parameter includes at least one of a polymerization temperature, an irradiating time, and an irradiating intensity.

14. The method of claim 13, wherein the polymerization reaction further includes:
using ultraviolet light having an even intensity to irradiate the entire liquid crystal layer,
wherein an irradiating time of the first portion of the liquid crystal layer is shorter than an irradiating time of the second portion of the liquid crystal layer.

15. The method of claim 13, wherein the polymerization process further includes:
applying a same irradiating time to the entire liquid crystal layer,
wherein an ultraviolet intensity for irradiating the first portion of the liquid crystal layer is weaker than an ultraviolet intensity for irradiating the second portion of the liquid crystal layer.

16. The method of claim 10, wherein forming the liquid crystal layer includes:
forming a plurality of cavities between the first substrate and the second substrate; and
filling mixtures of a liquid crystal material and a plurality of monomers into each of the plurality of cavities respectively, wherein one of the plurality of cavities has a larger distance from the light source is filled with a mixture having a higher concentration of the monomers.
